(19) United States
(12) Patent Application Publication
(10) Pub. No.: US 2025/0189396 A1
(43) Pub. Date: Jun. 12, 2025

(54) METHODS AND APPARATUS FOR VAPOR PRESSURE MONITORING

(71) Applicant: ASM IP Holding B.V., Almere (NL)

(72) Inventors: Nirmal Gokuldas Waykole, Tempe, AZ (US); Qi Qi, Phoenix, AZ (US); Shreyans Kedia, Tempe, AZ (US)

(21) Appl. No.: 18/744,884

(22) Filed: Jun. 17, 2024

Related U.S. Application Data
(60) Provisional application No. 63/522,103, filed on Jun. 20, 2023.

(51) Int. Cl. G01L 19/00; G01L 23/26

(52) U.S. Cl. CPC G01L 19/0038; G01L 23/26; G01L 2019/0053

(57) ABSTRACT

Various embodiments of the present technology may provide methods and apparatus for vapor pressure monitoring in a semiconductor manufacturing tool. The apparatus may include a vessel containing a chemistry and a outlet connected to a gas line, wherein the gas line includes a first section that is connected to a reactor and second section that is connected an exhaust port. The gas line may also include a third section connected to a pressure sensor.

### CROSS-REFERENCE TO RELATED APPLICATIONS

This application is a nonprovisional of, and claims priority to and the benefit of, U.S. Provisional Patent Application No. 63/522,103, filed Jun. 20, 2023 and entitled “METHODS AND APPARATUS FOR VAPOR PRESSURE MONITORING,” which is hereby incorporated by reference herein.

### FIELD OF INVENTION

The present disclosure generally relates to a method and apparatus for vapor pressure monitoring. More particularly, the present disclosure relates to an enclosure having a through-hole to receive a feedthrough gas line, wherein the feedthrough gas line has an internal heating element and the feedthrough gas line is coupled to a pressure sensor located outside the enclosure.

### BACKGROUND OF THE TECHNOLOGY

Conventional semiconductor manufacturing systems experience gas lines with cold spots causing condensation, which may lead to non-uniform deposition on the wafer. In addition, measuring vapor pressure through the gas lines is inaccurate when the vapor pressure is low.

### SUMMARY OF THE INVENTION

Various embodiments of the present technology may provide methods and apparatus for vapor pressure monitoring in a semiconductor manufacturing tool. The apparatus may include a vessel containing a chemistry and a outlet connected to a gas line, wherein the gas line includes a first section that is connected to a reactor and second section that is connected an exhaust port. The gas line may also include a third section connected to a pressure monitor.

In one aspect, an apparatus comprises: a gas line; a metal body surrounding a segment of the gas line, wherein the metal body comprises: a heater rod embedded within the metal body; and a first thermocouple connected to the metal body; and an insulator surrounding a portion of the metal body.

In one embodiment, a portion of the heater rod extends outside the metal body.

In one embodiment, the insulator surrounds the portion of the heater rod that extends outside the metal body.

In one embodiment, the insulator is separated from the metal body by an air gap.

In one embodiment, the gas line extends through the insulator.

In one embodiment, the metal body is formed from stainless steel.

In one embodiment, the metal body further comprises a second thermocouple.

In one embodiment, the metal body further comprises a second thermocouple and wherein the first thermocouple is arranged at a first side of the metal body and the second thermocouple is arranged at a second side of the metal body, opposite the first side.

In another aspect, an apparatus comprises: a first cabinet comprising a first wall having a first through-hole; a second cabinet disposed within the first cabinet and comprising a second wall in parallel with the first wall, wherein the second wall comprises a second through-hole aligned with the first through-hole; a gas line system comprising a feedthrough device disposed and extending through the first and second through-holes, the feedthrough device comprising: a gas line; a metal body surrounding a segment of the gas line, wherein the metal body comprises: a heater rod comprising a first section embedded within the metal body and a second section extending outside the metal body; and a first thermocouple connected to the metal body; and an insulator surrounding a portion of the metal body and the second section of the heater rod.

In one embodiment, the metal body further comprises a second thermocouple.

In one embodiment, the metal body is formed from stainless steel.

In one embodiment, the insulator comprises polyether ether ketone (PEEK).

In one embodiment, the second cabinet is separated from the first cabinet by an air gap.

In one embodiment, the apparatus further comprises a pressure sensor coupled to the gas line and disposed outside of the first cabinet.

In yet another aspect, a system comprises: a reactor; a first cabinet comprising a first wall having a first through-hole; a second cabinet disposed within the first cabinet and comprising a second wall in parallel with the first wall, wherein the second wall comprises a second through-hole aligned with the first through-hole, wherein the second cabinet is separated from the first cabinet by an air gap; a vessel disposed within the second cabinet; a gas line connected to the vessel and disposed within the first and second through-holes comprising: a first section connected to the reactor; a second section connected to an exhaust port; and a third section connected to a pressure sensor, wherein the third section extends through the first and second enclosures, and the pressure sensor is disposed outside of the second enclosure.

In one embodiment, the third section comprises a feedthrough device disposed and extending through the first and second through-holes, the feedthrough device comprising: a gas line; and a metal body surrounding a segment of the gas line.

In one embodiment, the metal body comprises: a heater rod comprising a first section embedded within the metal body and a second section extending outside the metal body; and a first thermocouple connected to the metal body.

In one embodiment, the system further comprises an insulator surrounding a portion of the metal body and the second section of the heater rod, wherein the insulator comprises polyether ether ketone.

In one embodiment, the metal body further comprises a second thermocouple opposite the first thermocouple.

In one embodiment, the metal body is formed from stainless steel.

### BRIEF DESCRIPTION OF THE DRAWING FIGURES

A more complete understanding of the present technology may be derived by referring to the detailed description when considered in connection with the following illustrative figures. In the following figures, like reference numbers refer to similar elements and steps throughout the figures.

FIG. 1 representatively illustrates a system in accordance with various embodiments of the present technology;

FIG. 2A representatively illustrates a perspective view of an enclosure of the system in accordance with various embodiments of the present technology;

FIG. 2B representatively illustrates a side view of the enclosure in accordance with various embodiments of the present technology;

FIG. 3 illustrates a feedthrough section of a gas line in accordance with various embodiments of the present technology;

FIG. 4 illustrates a cross-sectional view of the feedthrough section in accordance with various embodiments of the present technology;

FIG. 5 is a cross-sectional view of the feedthrough section in accordance with various embodiments of the present technology; and

FIG. 6 is a schematic of the system in accordance with various embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results.

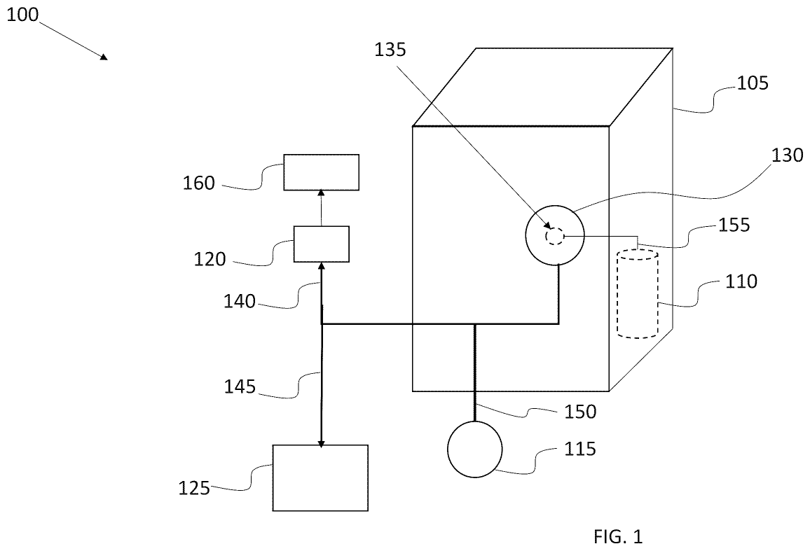

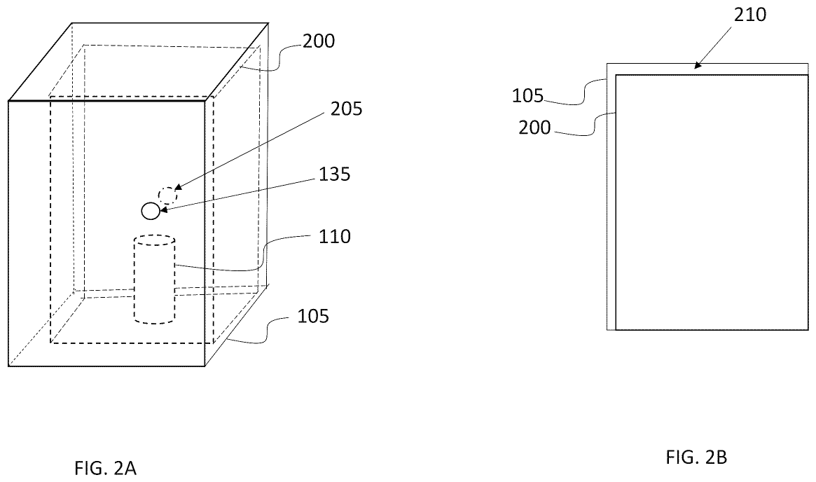

In various embodiments, and referring to FIGS. 1 and 2, a system 100 may comprise a first enclosure 105 (e.g., a cabinet) and a second enclosure 200 (e.g., a cabinet). Each enclosure 105, 200 may comprise a plurality of sidewalls, a bottom, and a top. The first enclosure 105 may surround the second enclosure 200, and the second enclosure 200 may be separated from the first enclosure 105 by an air gap 210. The first and second enclosures 105, 200 may be formed from a metal material, such as stainless steel or the like. The first enclosure 105 may comprise a first through-hole 135 within a vertically-oriented sidewall of the first enclosure 105. Similarly, the second enclosure 200 may comprise a second through-hole 205 within a vertically oriented sidewall of the second enclosure, such that the first through-hole 135 is horizontally aligned with the second through-hole 205.

The second enclosures 200 may be heated. For example, the system 100 may comprise a heating system (not shown) disposed within or near the second enclosure 200, such as a radiant heat source, a convection heat source, conduction heat source, or other suitable heat source to heat the interiors of the second enclosures 200.

In various embodiments, the system 100 may further comprise a vessel 110 disposed within the second enclosure 200. The vessel 110 may be configured to hold or otherwise contain a chemical; the chemical may be a solid chemical or a liquid chemical. The vessel 110 may comprise an outlet port, and the outlet port may be connected to a gas line system. In various embodiments, the vessel 110 may further comprise an inlet (not shown) configured to deliver an inert gas (not shown), such as argon, into the vessel. The inert gas may be used as a carrier gas to assist in flowing the chemical vapor to the reactor 160.

In various embodiments, the gas line system may comprise a first section 140, a second section 145, and a third section 150. The first, second, and third sections 140, 145, 150 may be in fluid communication with each other. The first section 140 may be connected to a reactor 160. In particular, the first section 140 may fluidly connect the vessel 110 to the reactor 160. The second section 145 may be connected to an exhaust system 125. The exhaust system 125 may comprise a pump (not shown) configured to evacuate gas from the gas line.

The third section 150 may extend out of and through the first and second enclosures 105, 200 and may be connected to a pressure sensor 115, such as a pressure transducer. For example, the pressure sensor 115 may comprise a pressure transducer or other device or system suitable for measuring a vapor pressure. In an exemplary embodiment, the pressure sensor 115 is disposed exterior to the first enclosure 105. The pressure sensor 115 may be configured to monitor a vapor pressure of the of the chemistry in the vessel 110.

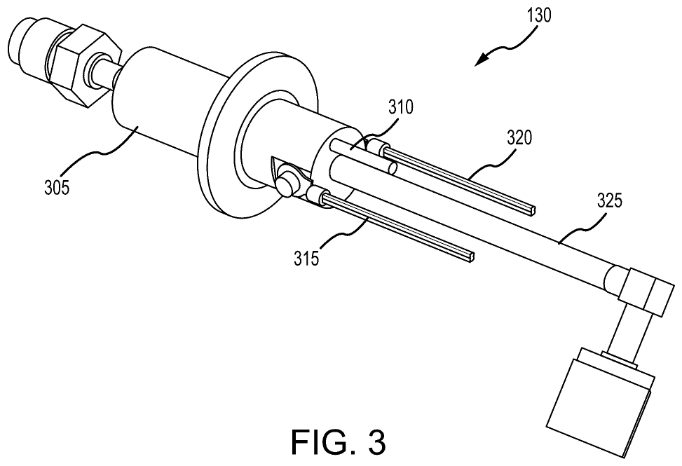

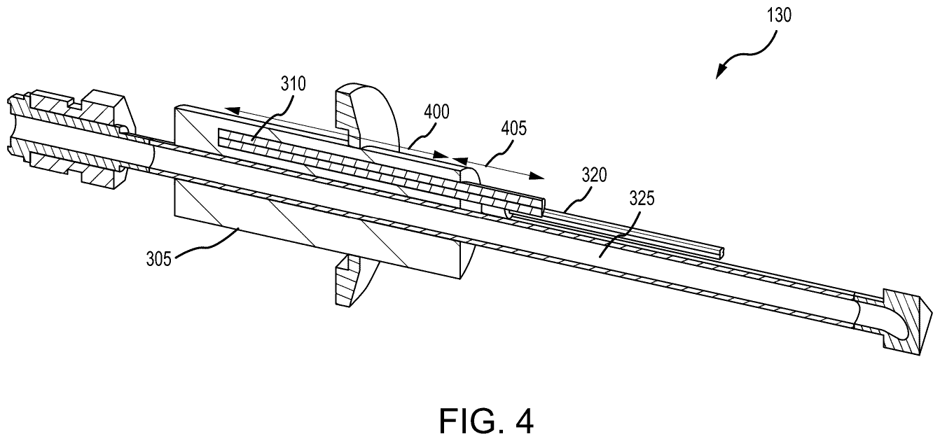

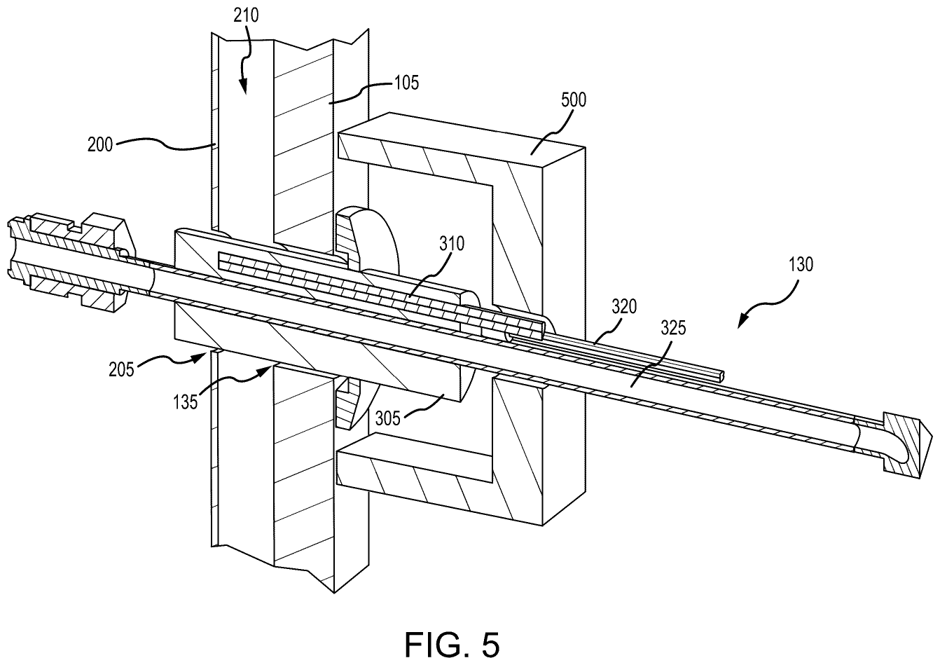

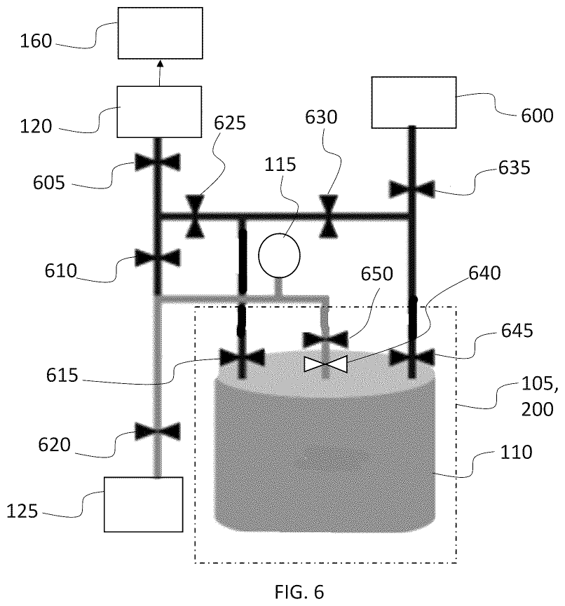

In various embodiments, and referring to FIGS. 2-5, the third section 150 may comprise a feedthrough device 135 that extends through the though-holes of the first and second enclosures 105, 200. The feedthrough device 135 may comprise a gas line 325. The feedthrough device 135 may further comprise a metal body 305 surrounding a segment of the gas line 325. In particular, the metal body 305 may be in direct contact with the gas line 325 and radially surround the gas line 325. In an exemplary embodiment, the metal body 305 is formed from stainless steel. In an exemplary embodiment, the metal body 305 extends from the interior of the second enclosure 200, through the air gap 210, and to an exterior of the first enclosure 105. A larger portion of the metal body 305 may extend outwards from the exterior of the first enclosure 105.

In various embodiments, the metal body 305 may comprise a heater rod 310 configured to heat the metal body 305 and the gas line 325. The heater rod 310 may be embedded within the metal body 305 and a first portion 400 of the heater rod 310 may extend through substantially the length of the metal body 305. A portion of the heater rod 310 may extend outside the metal body 305. In an exemplary embodiment, a second portion 405 of the heater rod 310 is exposed (i.e., not embedded within the metal body) and extends outwards from the metal body 305, and outwards from the exterior of the first enclosure 105. The heater rod 310 may comprise a resistive type heater or any other suitable heating element.

In various embodiments, the metal body 305 may further comprise a temperature sensor, such as a first thermocouple 315 and a second thermocouple 320. The first thermocouple 315 may be attached (e.g., using a lug) a first side of the metal body 305 and the second thermocouple 320 may be attached (e.g., using a lug) to a second side, opposite the first side, of the metal body 305.

In various embodiments, the system 100 may further comprise an insulator 500 disposed exterior to the first enclosure 105 and encapsulate a portion of the feedthrough device 135. For example, the insulator 500 may surround a portion of the metal body 305 containing the heater rod 310 as well as the second portion 405 of the heater rod 310 that is exposed. The insulator 500 may comprise a through-hole for receiving at least a portion of the feedthrough device 130, such as the gas line 325, the second portion 405 of the heater rod 310, and the thermocouples 315, 320. In an exemplary embodiment, the insulator 500 is formed from PEEK (polyether ether ketone). The insulator 500 may comprise a two-piece system coupled together. A surface of the insulator 500 may directly contact the sidewall of the first enclosure 105.

In various embodiments, the system 100 may further comprise an accumulator 120 interposed between the vessel 110 and the reactor 160. The accumulator 120 may operate to contain the vapor temporarily before it is released into the reactor 160.

In various embodiments, the system 100 may further comprise a plurality of valves. For example, the system 100 may comprise a first valve 605, a second valve 615, a third valve 610, a third valve 620, a fourth valve 640, a fifth valve 645, and a sixth valve 650, a seventh valve 625, and eighth valve 630, a ninth valve 635, and a tenth valve 610. Some valves may be disposed within the first and second enclosures 105, 200, such as valves the second valve 615, the fourth valve 640, the fifth valve 645, and the sixth valve 650. The fourth and sixth valves 640, 650 may be disposed along the gas line that connects the vessel 110 to the reactor 160 and the pressure sensor 115. The fifth valve may be disposed coupled to the inlet of the vessel 110. Valve 620 may be disposed upstream from the exhaust system 125. The tenth valve 610 may be disposed along the first section of the gas line and upstream from valves 640 and 650. The plurality of valves may be in communication with and operated by a control system (not shown), such as a controller or processor. Accordingly, the control system may operate the position of the valves to be open or closed.

In operation, the vapor pressure of the chemistry in the vessel may be measured using the pressure sensor 115. During vapor pressure measuring, valves 645, 615, 605, 610 and 620 will be closed, while valves 640 and 650 will be open. This will allow the vapor/gas to flow through feedthrough device 130 and into the pressure sensor 115.

The measured vapor pressure may be transmitted to the control system. The measured pressure may be displayed on a user interface connected to or integrated within the control system. In some cases, the control system may automatically respond to the measured vapor pressure and activate other systems to effect an increase or decrease in the vapor pressure to achieve a desired pressure. For example, the control system may increase the temperature of the second enclosure 200, and thus, the vessel 110, if the measured vapor pressure is less than desired. Conversely, the control system may decrease the temperature of the second enclosure and vessel 110 if the measured vapor pressure is higher than desired. Increasing the temperature of second enclosure 200 and vessel 110 will increase the vapor pressure of the chemistry in the vessel 110, and conversely, decreasing the temperature of the second enclosure 200 and vessel 110 will decrease the vapor pressure of the chemistry in the vessel 110. The temperature of the second enclosure 200 and the vessel 110 may be increased incrementally until the desired vapor pressure is reached. In other cases, tuning of other systems, such as the heating system for the second enclosure 200 and the vessel 110, may be performed manually by a user.

Once the vapor pressure has been measured, the system 100 may remove/evacuate chemistry in the gas line by operating the pump and closing valves 615, 645, 640, and 605. During this removal/evacuation process, valve 620 will be open.

Once the gas line has been evacuated, the system 100 may return to a normal deposition process of pulsing and purging. For example, during a pulse, vapor may be flowed from the vessel 110 to the reactor 160 for a predetermined time. During a purge, an inert gas may be flowed into the reactor 160 and to the exhaust system 125 for a predetermined time. The pulse and purge sequence may be repeated any number of times.

The vapor pressure of the chemistry may also be increased or decreased by changing the length of the pulse time. Accordingly, if the measured vapor pressure is higher or lower than desired, the system 100 (or the user) may increase or decrease the pulse time to increase or decrease the vapor pressure.

The vapor pressure of the chemistry may also be increased or decreased by changing the dilution of the chemical vapor. This may be achieved by increasing or decreasing the amount of the inert (carrier) gas that is flowed into the vessel. Accordingly, if the measured vapor pressure is higher or lower than desired, the system 100 (or the user) may increase or decrease the amount of inert gas that is flowed into the vessel.

In the foregoing description, the technology has been described with reference to specific exemplary embodiments. The particular implementations shown and described are illustrative of the technology and its best mode and are not intended to otherwise limit the scope of the present technology in any way. Indeed, for the sake of brevity, conventional manufacturing, connection, preparation, and other functional aspects of the method and system may not be described in detail. Furthermore, the connecting lines shown in the various figures are intended to represent exemplary functional relationships and/or steps between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology, as expressed in the following claims.

What is claimed is:

1. An apparatus, comprising:
a gas line;
a metal body surrounding a segment of the gas line, wherein the metal body comprises:
a heater rod embedded within the metal body; and
a first thermocouple connected to the metal body; and
an insulator surrounding a portion of the metal body.

2. The apparatus according to claim 1, wherein a portion of the heater rod extends outside the metal body.

3. The apparatus according to claim 2, wherein the insulator surrounds the portion of the heater rod that extends outside the metal body.

4. The apparatus according to claim 1, wherein the insulator is separated from the metal body by an air gap.

5. The apparatus according to claim 1, wherein the gas line extends through the insulator.

6. The apparatus according to claim 1, wherein the metal body is formed from stainless steel.

7. The apparatus according to claim 1, wherein the metal body further comprises a second thermocouple.

8. The apparatus according to claim 1, wherein the metal body further comprises a second thermocouple and wherein the first thermocouple is arranged at a first side of the metal body and the second thermocouple is arranged at a second side of the metal body, opposite the first side.

9. An apparatus, comprising:
a first cabinet comprising a first wall having a first through-hole;
a second cabinet disposed within the first cabinet and comprising a second wall in parallel with the first wall, wherein the second wall comprises a second through-hole aligned with the first through-hole;
a gas line system comprising a feedthrough device disposed and extending through the first and second through-holes, the feedthrough device comprising:
a gas line;
a metal body surrounding a segment of the gas line, wherein the metal body comprises:
a heater rod comprising a first section embedded within the metal body and a second section extending outside the metal body; and
a first thermocouple connected to the metal body; and
an insulator surrounding a portion of the metal body and the second section of the heater rod.

10. The apparatus according to claim 9, wherein the metal body further comprises a second thermocouple.

11. The apparatus according to claim 9, wherein the metal body is formed from stainless steel.

12. The apparatus according to claim 9, wherein the insulator comprises polyether ether ketone (PEEK).

13. The apparatus according to claim 9, wherein the second cabinet is separated from the first cabinet by an air gap.

14. The apparatus according to claim 9, further comprising a pressure sensor coupled to the gas line and disposed outside of the first cabinet.

15. A system, comprising:
a reactor;
a first cabinet comprising a first wall having a first through-hole;
a second cabinet disposed within the first cabinet and comprising a second wall in parallel with the first wall, wherein the second wall comprises a second through-hole aligned with the first through-hole, wherein the second cabinet is separated from the first cabinet by an air gap;
a vessel disposed within the second cabinet; and
a gas line connected to the vessel and disposed within the first and second through-holes comprising:
a first section connected to the reactor;
a second section connected to an exhaust port; and
a third section connected to a pressure sensor, wherein the third section extends through the first and second enclosures, and the pressure sensor is disposed outside of the second enclosure.

16. The system according to claim 15, wherein the third section comprises a feedthrough device disposed and extending through the first and second through-holes, the feedthrough device comprising:
a gas line; and
a metal body surrounding a segment of the gas line.

17. The system according to claim 16, wherein the metal body comprises:
a heater rod comprising a first section embedded within the metal body and a second section extending outside the metal body; and
a first thermocouple connected to the metal body.

18. The system according to claim 17, further comprising an insulator surrounding a portion of the metal body and the second section of the heater rod, wherein the insulator comprises polyether ether ketone.

19. The system according to claim 17, wherein the metal body further comprises a second thermocouple opposite the first thermocouple.

20. The system according to claim 15, wherein the metal body is formed from stainless steel.
